(19) United States
(12) Patent Application Publication
(10) Pub. No.: US 2014/0064520 A1
(43) Pub. Date: Mar. 6, 2014

(54) TERMINAL WITH A PIEZOELECTRIC SPEAKER SYSTEM AND METHOD FOR OPERATING THEREOF

(71) Applicant: Pantech Co., Ltd., Seoul (KR)

(72) Inventor: Myeong Je KIM, Seoul (KR)

(73) Assignee: Pantech Co., Ltd., Seoul (KR)

(21) Appl. No.: 14/014,554

(22) Filed: Aug. 30, 2013

(30) Foreign Application Priority Data
Aug. 31, 2012 (KR) 10-2012-0096077

(51) Int. Cl. H04R 17/00

(52) U.S. Cl. CPC H04R 17/00
USPC 381/120

(57) ABSTRACT

A terminal having a piezoelectric speaker system includes a control unit to generate a sound source signal, a first amplification unit to provide a voltage to amplify the sound source signal, and a piezoelectric module to vibrate according to the amplified sound source signal, the piezoelectric module being configured to transmit vibrations to a contact medium to generate a sound. A method for generating a sound using a piezoelectric speaker includes amplifying a sound source signal, generating a vibration in a piezoelectric module according to the amplified sound source signal, and transmitting vibration to a contact medium for generating the sound.

### CROSS-REFERENCE TO RELATED APPLICATION

This application claims priority to and the benefit under 35 U.S.C. §119(a) of Korean Patent Application No. 10-2012-0096077, filed on Aug. 31, 2012, the entire disclosure of which is incorporated by reference for all purposes.

### BACKGROUND

1. Field

The following disclosure relates to a terminal having a piezoelectric system and a method for operating thereof for generating a sound.

2. Discussion of the Background

As use of various electronic devices has increased and applied in everyday life, is there is a demand for new forms of user interfaces that have good quality and appeal to sensibilities. One device exposed to users includes a speaker that provides sound.

A speaker used in a terminal has a small volume due to structure restrictions and may have degraded performance in terms of sound volume and tone when compared to an exterior speaker. In order to compensate for the degraded performance of the terminal speaker, a vibration speaker that generates sound using an external medium, a dynamic speaker, has been developed. However, a general dynamic speaker method requires a large volume to implement a vibrator.

FIG. 1 illustrates a dynamic speaker in a terminal according to a related art.

FIG. 1 illustrates a dynamic speaker 20, in which a magnetic field is generated when an audio output is applied to a coil 22. Vibration is generated by a force generated between the generated magnetic field and a magnet 24, and this vibration is transmitted to a contact medium 26 to generate sound.

Such a dynamic speaker structure includes a magnet and a coil to generate vibration, which requires an increase in volume. Thus, there is a problem in that it is difficult to achieve a terminal-integrated configuration to implement the dynamic speaker structure. Therefore, the dynamic speaker may not be directly integrated into terminals and is used only in the forms of accessories, such as an external speaker unit.

A piezoelectric speaker, as a speaker that overcomes the limitation on the thickness has been applied to portable devices or other thin portable devices.

FIG. 2 illustrates a piezoelectric speaker in a terminal according to a related art.

Referring to FIG. 2, a piezoelectric speaker 40 having a film form, in which various designs are possible, has been used. In the piezoelectric speaker 40, a vibration film 44 is joined to a piezoelectric element 42 disposed between a front surface case 46 and a rear surface case 48. Vibration generated in the piezoelectric element 42 is directly transmitted to the vibration film 44 to generate a sound.

A piezoelectric technology achieves a small, light, and simple structure, which allows for a high driving force, low power consumption, non-electromagnetic waves, and linear driving without additional devices. Accordingly, the piezoelectric technology is also applied to motors, camera actuators, and the like as well as speakers.

However, with respect to the piezoelectric speaker, although the physical volume may be reduced in comparison to general dynamic speakers, a volume above a reference threshold has to be ensured. In addition, there is a problem in that performance is degraded when compared to the general dynamic speakers.

Therefore, there is a demand for the development of a piezoelectric speaker, which has a reduced physical volume with improved sound quality.

### SUMMARY

Exemplary embodiments of the present invention provide a terminal having a piezoelectric speaker system and a method for operating thereof for generating a sound.

Additional features of the invention will be set forth in the description which follows, and in part will be apparent from the description, or may be learned by practice of the invention.

Exemplary embodiments of the present invention provide a terminal having a piezoelectric speaker system including a control unit to generate a sound source signal; a first amplification unit to provide a voltage to amplify the sound source signal; and a piezoelectric is module to vibrate according to the amplified sound source signal, the piezoelectric module being configured to transmit vibrations to a contact medium to generate a first sound.

Exemplary embodiments of the present invention provide a method for generating a sound using a piezoelectric speaker including amplifying a sound source signal; generating a vibration in a piezoelectric module according to the amplified sound source signal; and transmitting vibration to a contact medium for generating the sound.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a dynamic speaker in a terminal according to a related art.

FIG. 2 illustrates a piezoelectric speaker in a terminal according to a related art.

FIG. 3 is a block diagram of a piezoelectric speaker system of a terminal according to an exemplary embodiment of the present invention.

FIG. 4 is a circuit diagram of the piezoelectric speaker system of FIG. 3.

FIG. 5 is a cross-sectional view of a configuration of the piezoelectric module of FIG. 3.

FIG. 6 is a conceptual diagram illustrating a change in a state of a piezoelectric module according to an applied voltage according to an exemplary embodiment of the present invention.

FIG. 7 is a conceptual diagram illustrating an operation of the piezoelectric speaker system of FIG. 3.

FIG. 8A and FIG. 8B are diagrams illustrating a configuration of a terminal having a piezoelectric module according to exemplary embodiments of the present invention.

FIG. 9A is a diagram illustrating a configuration of a terminal having a piezoelectric module according to exemplary embodiments of the present invention.

FIG. 9B is a cross-sectional of an enclosure containing a piezoelectric module according to exemplary embodiments of the present invention.

FIG. 10A and FIG. 10B are diagrams illustrating a case of a terminal according to exemplary embodiments of the present invention.

FIG. 11A and FIG. 11B are diagrams illustrating a case of a terminal according to exemplary embodiments of the present invention.

FIG. 12A and FIG. 12B are diagrams illustrating a configuration of a terminal according to exemplary embodiments of the present invention.

FIG. 13A and FIG. 13B are diagrams illustrating a configuration of a terminal according to exemplary embodiments of the present invention.

FIG. 14 is a flowchart illustrating a method for operating a piezoelectric speaker according to an exemplary embodiment of the present invention.

FIG. 15 is a block diagram illustrating a configuration of a piezoelectric speaker system according to exemplary embodiments of the present invention.

FIG. 16 is a block diagram illustrating a configuration of a piezoelectric speaker system according to exemplary embodiments of the present invention.

FIG. 17 is a block diagram illustrating a configuration of a piezoelectric speaker system according to exemplary embodiments of the present invention.

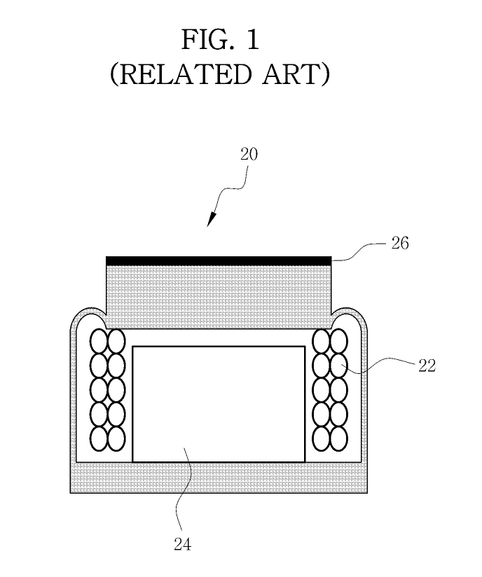

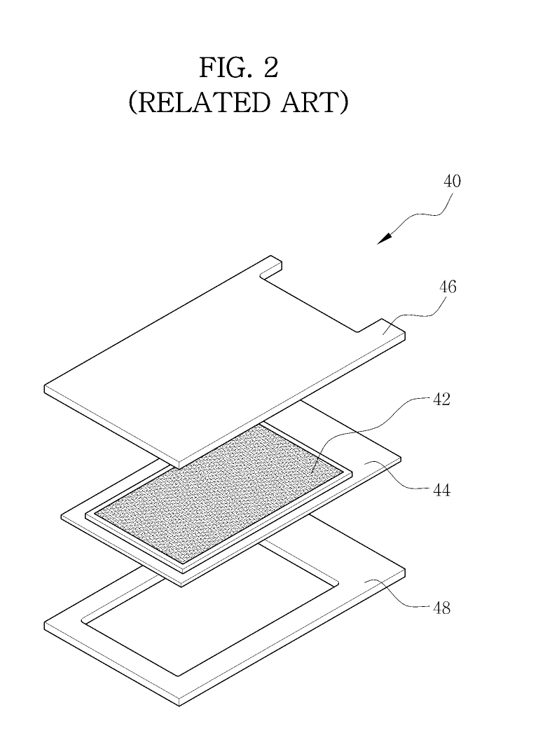

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they is are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

According to various aspects of the present invention, a piezoelectric module may contact a body directly or indirectly and/or transmit vibrations to the body directly or indirectly, for example, through air or another body or medium. Further, the piezoelectric module may be disposed within a reference proximity to a body and transmit vibrations thereto to generate a sound.

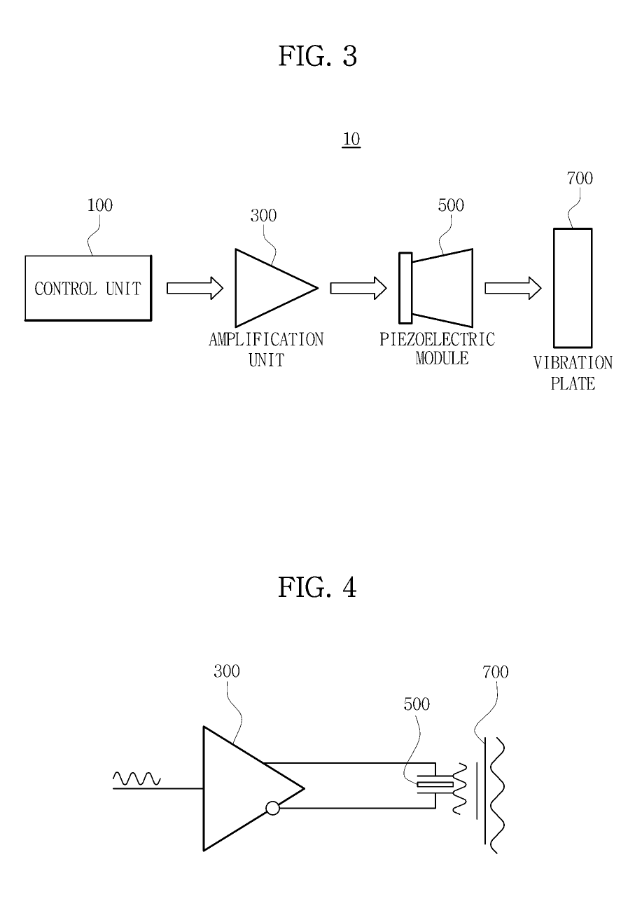

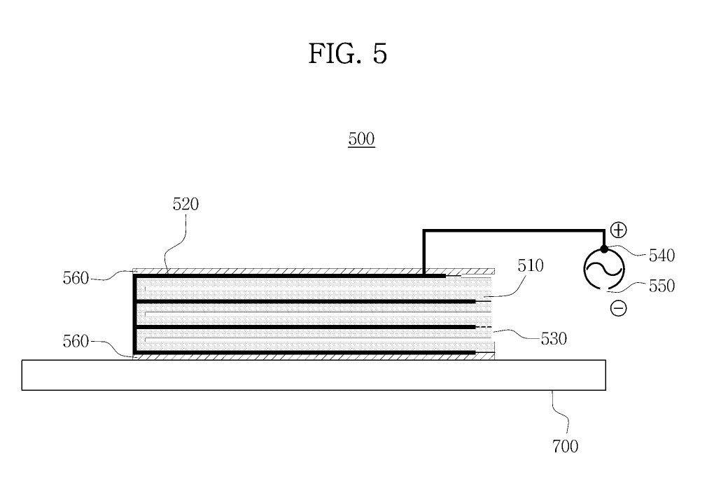

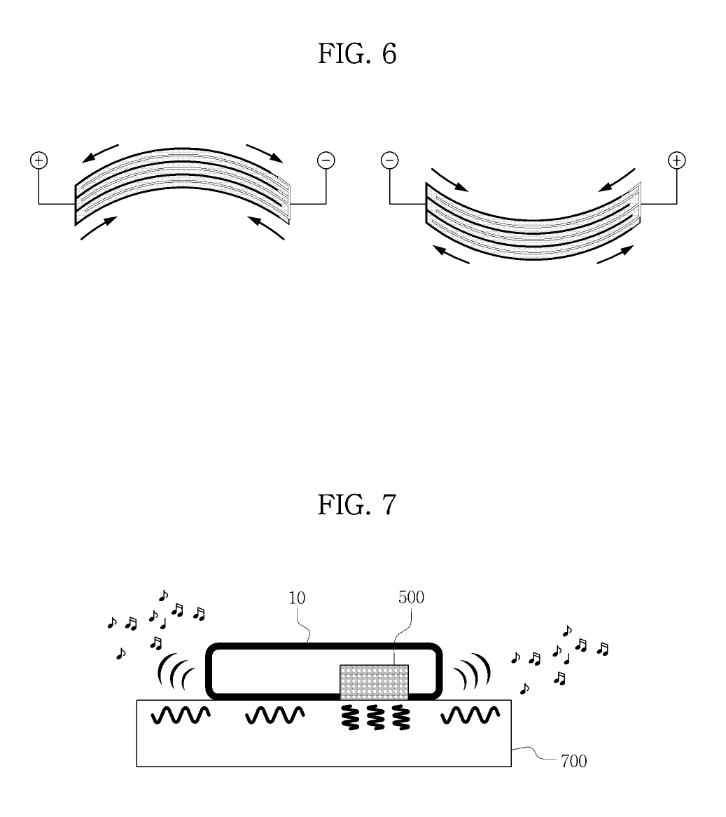

FIG. 3 is a block diagram of a piezoelectric speaker system of a terminal according to an exemplary embodiment of the present invention. FIG. 4 is a circuit diagram of a piezoelectric speaker system of FIG. 3. FIG. 5 is a cross-sectional view of a configuration of the piezoelectric module of FIG. 3. FIG. 6 is a conceptual diagram illustrating a change in a state of a piezoelectric module according to an applied voltage according to an exemplary embodiment of the present invention. FIG. 7 is a conceptual diagram illustrating an operation of the piezoelectric speaker system of FIG. 3.

Referring to FIG. 3 and FIG. 4, piezoelectric speaker system 10 includes a piezoelectric module 500 and a vibration plate 700. The piezoelectric speaker system 10 may further include a control unit 100 and an amplification unit 300.

The piezoelectric speaker system 10 may be mounted in or connected to the terminal or may be an independent speaker unit. Examples of the terminal may include, without limitation, mobile terminals, such as smartphones, tablet computers, netbooks, personal digital assistants (PDA), portable media players (PMP), the PlayStation Portable (PSP), Moving Picture Experts Group (MPEG)-1 or MPEG-2 Audio Layer III (MP3) players, e-book readers, navigation systems, digital cameras, electronic dictionaries, and electronic watches.

The control unit 100 may manage one or more operations of the terminal and may output various signals. The control unit 100 may output a sound source signal provided to the piezoelectric module 500. The sound source signal may be a signal in the form of an analog voltage. In addition, the sound source signal may be carried by a carrier wave to be outputted.

The amplification unit 300 may amplify the sound source signal. The amplification unit 300 may output a voltage above a reference threshold, for example, an alternating current voltage of 10 Peak-to-Peak voltage (Vpp) or higher to drive the piezoelectric module. Further, the amplification unit 300 may include an amplifier, which may be capable of outputting a voltage above a reference threshold.

The piezoelectric module 500 may include a piezoelectric element. The piezoelectric element may be referred to as an element having properties in which a potential difference may be generated by electric polarization when an external force is exerted. Piezoelectric effect may refer to a deformation or stress that may occur when a voltage is applied. Examples of the piezoelectric element may include, without limitation, crystals, tourmaline, Rochelle salt, barium titanate (BaTiO₃), ammonium dihydrogen phosphate (NH₄H₂PO₄), and artificial ceramic (PZT).

Referring to FIG. 5, the piezoelectric module 500 includes a piezoelectric element 510, a first electrode 520 and a second electrode 530, which are respectively disposed at the upper portion and the lower portion of the piezoelectric element 510, and a first socket 540 and a second socket 550, which are respectively connected to the first electrode 520 and the second electrode 530.

In addition, the piezoelectric module 500 may further include a coating layer 560. The coating layer 560 may adhere the piezoelectric module 500 to a contact medium, such as the vibration plate 700 or an external structure, and may protect the piezoelectric module 500. As the coating layer 560, polyurethane, other synthetic materials, or the like may be used.

The piezoelectric element 510 may be formed of a single layer or multiple layers. When the piezoelectric element 510 has multiple layers, the first electrode 520 and the second electrode 530 may be disposed in one or more layers of the piezoelectric element 510. The first electrode 520 and the second electrode 530 respectively serve as a (+) socket and a (−) socket or vice versa and may include, without limitation, at least one of platinum (Pt), titanium (Ti), and silver (Ag).

The first socket 540 and the second socket 550 are respectively connected to the first electrode 520 and the second electrode 530 to apply the sound source signal output. The sound source signal output may be provided from the control unit 100 or the amplification unit 300 to at least one of the first electrode 520 and the second electrode 530. The first socket 540 and the second socket 550 may be a socket or a flexible printed circuit board (FPCB).

The piezoelectric effect may change a mechanical change into an electrical change. When a compressive force or a tensile force is exerted on the piezoelectric element 510 is from the outside, (+) charges and (−) charges move in opposite directions to generate a voltage according to a potential difference.

Further, the inverse piezoelectric effect changes an electric change into a mechanical change. When a (+) voltage and a (−) voltage are respectively applied to the upper portion and the lower portion of the piezoelectric element 510, the piezoelectric element 510 may contract or relax. Therefore, as illustrated in FIG. 6, when alternating current voltages are respectively applied to the first electrode 520 and the second electrode 530 of the piezoelectric element 510, the piezoelectric element 510 may be repeatedly contracted and relaxed.

When the contraction and relaxation of the piezoelectric element 510 are repeated, the piezoelectric module 500 may vibrate. The vibration plate 700 may receive the vibration generated by the piezoelectric module 500 and may vibrate to generate sound (see FIG. 7). Referring to FIG. 7, the piezoelectric speaker system 10 includes the piezoelectric module 500, and the vibration plate 700 is external to the piezoelectric speaker system 10. For example, the vibration plate 700 that is external to the piezoelectric speaker system 10 may be at least one of a table, a box, a flexible object, a specialized vibration plate for generating sound, and the like.

Further, before the vibration plate 700 is joined to the piezoelectric module 500, sound may be generated when the piezoelectric element 510 vibrates. This phenomenon may occur because the piezoelectric element 510 may come into contact with a contact medium, such as another structure of the terminal in which the piezoelectric element 510 is mounted, and thus sound may be generated. Further, if the piezoelectric element 510 comes into contact with the vibration plate 700, a more complete sound may be implemented and sound volume and tone may be enriched.

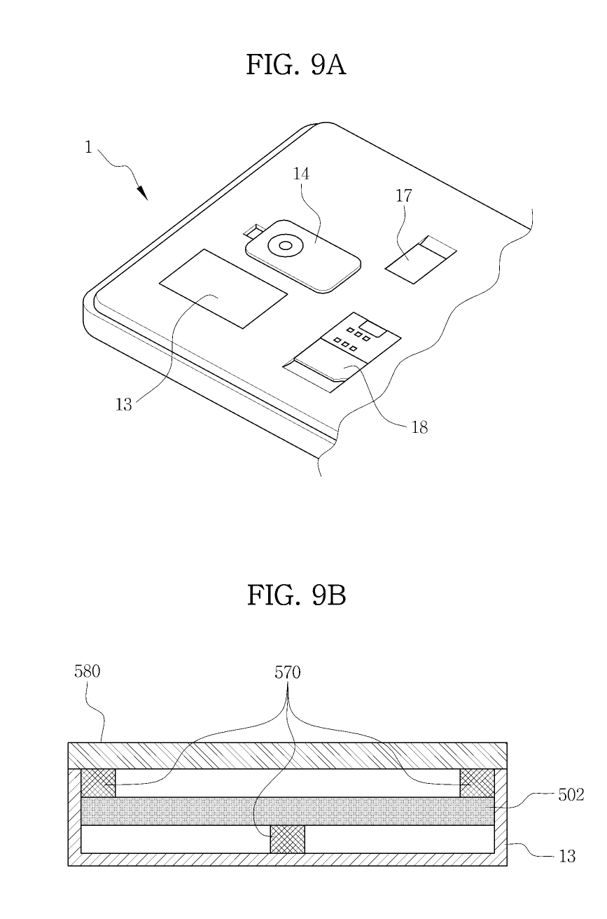

In addition, the piezoelectric module 500 may further include buffer units (not shown), which may be disposed at the upper portion and the lower portion of the piezoelectric module 500, and a reinforcement plate (not shown), which may be disposed on the front surface of the piezoelectric module 500. The buffer units and the reinforcement plate will be described later in more detail with reference to FIG. 9B.

The vibration plate 700 may be a case for the terminal or a contact medium outside the terminal. More specifically, the case of the terminal or the contact medium outside the terminal may act as the vibration plate of the piezoelectric speaker.

Therefore, the piezoelectric speaker system 10 according to exemplary embodiments of the present invention may not include the vibration plate 700 attached or connected thereto, and may be able to reduce the size or volume of the piezoelectric speaker.

When the case of the terminal serves as a vibration plate, the case of the terminal may refer to a surface of the case of the terminal. The surface of the case serving as the vibration plate may be a rear surface of the case or a front surface of the case. In addition, when the vibration plate 700 is the contact medium outside the terminal, the contact medium may be, without limitation, an object, which may have a resonance space and may be made of a flexible material, and may be an empty box, a table, a desk, or the like. Further, when the terminal including the piezoelectric speaker system 10 is placed on a box, a table, or the like, sound may be generated by the box or the table.

The material of the contact medium may include pulp, wood, a synthetic material, fiber, ceramic, a resin, polymer, or the like. However, aspects of the invention are not limited thereto. Sound generated by the vibration plate may vary in sound volume and tone based on, without limitation, at least one of a size, shape, and material of the vibration plate, a size of the resonance space, and the like. For example, as the size of the vibration plate is increased, is appropriate reproduction of low notes may be achieved, and as the size of the vibration plate is reduced, favorable reproduction of high notes may be achieved. In addition, when metal is used as the vibration plate material, a sound that may be expressed as being cold may be generated. As described above, the sound quality of the speaker may be based, at least in part, on the vibration plate.

Therefore, the piezoelectric speaker system 10 according to exemplary embodiments of the present invention may reproduce various tones based on the material of the vibration plate 700. More particularly, the piezoelectric speaker system 10 may compensate for the problem of the piezoelectric speaker which may be weak in a low note range by applying the outside contact medium.

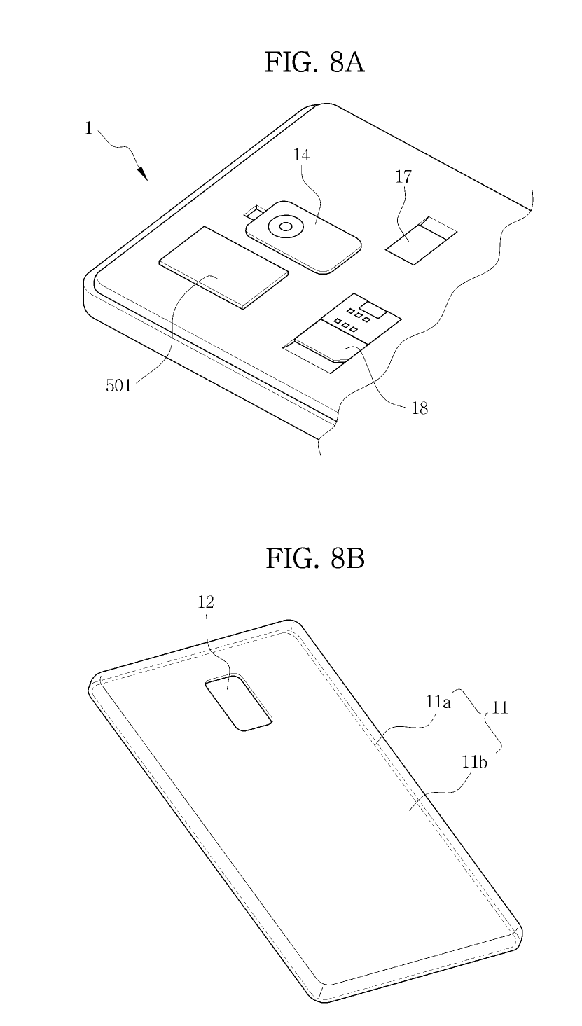

Hereinafter, mounting of piezoelectric module of the terminal according to exemplary embodiments of the present invention will be described with reference to FIGS. 8A to 13B. Piezoelectric modules described hereinafter may be substantially similar or the same as the piezoelectric module 500 of FIG. 3, and thus repeated descriptions of the same components as those of the piezoelectric module 500 of FIG. 3 will be simplified or omitted.

FIG. 8A and FIG. 8B are diagrams illustrate a configuration of a terminal having a piezoelectric module according to exemplary embodiments of the present invention.

Referring to FIG. 8A, a piezoelectric module 501 is disposed inside a terminal 1. Inside the terminal 1, a camera 14, a battery (not shown), and various internal elements, such as a Universal Subscriber Identity Module (USIM) chip 18 and a Secure Digital (SD) card 17 as well as the piezoelectric module 501 are disposed. Internal elements of the terminal 1 may be are covered by a case 11 as shown in FIG. 8B.

Referring to FIG. 8B, the case 11 has an interior surface 11a to face towards internal components of the terminal and an exterior surface 11b to face towards external environment. Case 11 is joined to the terminal 1, and the piezoelectric module 501, along with other internal components, may not be exposed to the outside environment, and may face an inner surface 11a of the case 11. In the case 11, a camera window 12 may be disposed to expose at least a portion of the camera 14 to the outside environment.

According to aspects of the invention, since the piezoelectric module 501 is disposed inside the terminal 1 and covered by the case 11, vibration generated by the piezoelectric module 501 may be transmitted to the case 11 directly or indirectly, for example, at least partially, almost completely, or completely through air. Also, the piezoelectric module 501 may transmit the generated vibration at least partially through the case 11 or another body or medium. The piezoelectric module 501 may be disposed to transmit vibrations to the case 11, i.e., the piezoelectric module 501 may be disposed to directly contact or to indirectly contact the case 11. Further, the piezoelectric module 501 may transmit vibrations to the case 11 while not contacting the case 11 but by being disposed within a reference proximity of the case 11. Therefore, the case 11 may receive vibration generated by the piezoelectric module 501 to generate a sound.

More specifically, the case 11 of the terminal 1 may serve as a vibration plate in the piezoelectric speaker system. In addition, when the case 11 comes into contact with an external contact medium, the vibration may be transmitted to the contact medium. Here, the contact medium may serve as another vibration plate to further amplify the sound.

The case 11 may be formed of a flexible material to serve as a vibration plate. More specifically, to achieve better sound transmission using effects of vibration, the case 11 may be configured to contact, at least in part, the piezoelectric module 501. However, the case 11 may not apply pressure above a reference threshold on the piezoelectric module 501 to provide for a close contact but may apply pressure below a reference threshold to come into contact therewith such that the case 11 touches the piezoelectric module 501. Therefore, the vibration of the piezoelectric module may be more appropriately transmitted.

In addition, the case 11 may be used as the vibration plate without exposing the piezoelectric module 501 to the outside environment. However, a case of the terminal may also have a form in which the piezoelectric module 501 may be exposed to the outside environment. If the case of the terminal is to have such a structure, an open space from which the piezoelectric module 501 may be exposed may be provided in the case, and the piezoelectric module 501 may be formed to be exposed and allow contact with an external contact medium. More specifically, the piezoelectric module 501 may be configured to be on the same plane as the case or protrude therefrom.

FIG. 9A is a diagram illustrating a configuration of a terminal having a piezoelectric module according to exemplary embodiments of the present invention. FIG. 9B is a cross-sectional of an enclosure containing a piezoelectric module according to exemplary embodiments of the present invention.

Referring to FIG. 9A and FIG. 9B, a piezoelectric module 502 is inserted into an enclosure 13 inside the terminal 1. The enclosure 13 may be a speaker box into which a speaker may be inserted and may constitute a part of the configuration of the terminal 1. Accordingly, the piezoelectric module 502, within the enclosure 13, is inserted into the terminal 1 along with components, and may be more protected from external impacts to increase the reliability of the terminal 1.

Referring to FIG. 9B, a cross-sectional view of the enclosure 13, which may be is inserted into the terminal 1, into which the piezoelectric module 502 is inserted is illustrated. Buffer units 570 are disposed on surfaces of the piezoelectric module 502 and a reinforcement plate 580 is formed to overlap at least one of the surfaces of the piezoelectric module 502. Further, the buffer units 570 may be located towards edge portions or a central region of the piezoelectric module 502. However, aspects of the invention are not limited thereto, such that buffer units may be disposed at various locations on a surface of a piezoelectric module.

The buffer units 570 may separate portions of the piezoelectric module 502 from the enclosure 13 or the case 11 and may aid in protecting the piezoelectric module 502 from external impacts. Further, the buffer units 570 may transmit vibration generated by the piezoelectric module 502 to the case 11 or the external contact medium.

The reinforcement plate 580 is disposed on the front or upper surface of the piezoelectric module 502. The reinforcement plate 580 may protect the surface of the piezoelectric module 502, and may increase the strength thereof. Since the piezoelectric module 502 may be a conductive element, voltage leakage may occur and low strength may be a characteristic. Therefore, the front or upper surface of the piezoelectric module 502 may be covered with the reinforcement plate 580. An acrylic material or the like may be used for the reinforcement plate 580. However, the configurations and materials of the buffer units 570 and the reinforcement plate 580 may be changed according to use.

In addition, the buffer units 570 and the reinforcement plate 580 according to exemplary embodiments of the present invention may be applied to other exemplary embodiments.

Although not illustrated, a FPCB may be disposed at the lower portion of the piezoelectric module 502 to transmit a sound source signal to the piezoelectric module 502.

Similar to the piezoelectric module 502 of FIG. 8A and FIG. 8B, the piezoelectric module 502 of FIG. 9A and FIG. 9B is formed inside the terminal 1 and is covered by the case 11. Therefore, vibration generated by the piezoelectric module 502 may be transmitted to the case 11. Therefore, the case 11 may receive the vibration to generate sound.

More specifically, the case 11 of the terminal 1 may serve as the vibration plate in the piezoelectric speaker system, and an external contact medium may serve as another vibration plate. Buffer units 570 may be disposed on a surface of the piezoelectric module 502.

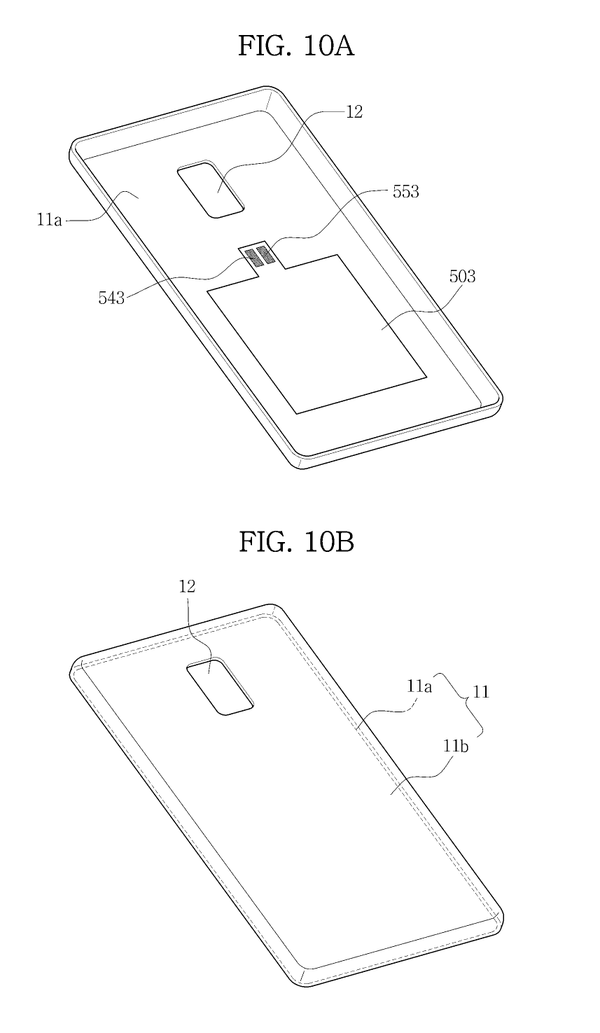

FIG. 10A and FIG. 10B are diagrams illustrating a case of a terminal according to exemplary embodiments of the present invention.

Referring to FIG. 10A, a piezoelectric module 503 may be disposed to be adhered to one surface of the case 11 of a terminal, more particularly, to the inner surface 11a. In addition, one or more sockets, more particularly, two sockets may be included in the piezoelectric module 503, which may be supplied with a sound source signal outputted from the control unit 100 or the amplification unit 300. In FIG. 10A, two sockets, more specifically, a first socket 543 and a second socket 553 are illustrated.

Another socket that may be electrically connected to the sockets for transmitting signals may be disposed in the main body of the terminal. The socket disposed in the main body may be configured to be electrically connected to the case when the case is joined to the main body of the terminal.

When the case 11 as in FIG. 10B is joined to the terminal, the piezoelectric module 503 may not exposed to the outside. Referring to FIG. 10A, the piezoelectric module 503 has a square or a rectangular shape with a protruding portion, in which the first socket 543 and the second socket 553 are disposed.

Since the piezoelectric module 503 is adhered to the inner surface 11a of the case of the terminal, vibration generated by the piezoelectric module 503 may be transmitted to the case 11. Therefore, the case 11 may receive the vibration to generate a sound. More specifically, the case 11 of the terminal may serve as the vibration plate in the piezoelectric speaker system, and an external contact medium may serve as another vibration plate.

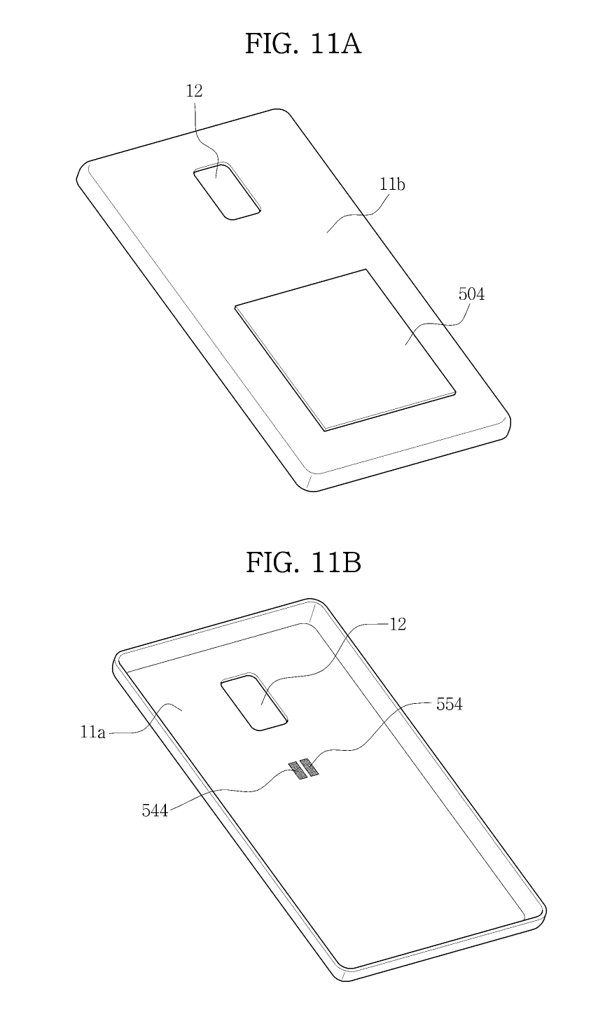

FIG. 11A and FIG. 11B are diagrams illustrating a case of a terminal according to exemplary embodiments of the present invention.

Referring to FIG. 11A, a piezoelectric module 504 may be disposed to be adhered to one surface of the case of the terminal, more particularly, to an outer surface 11b. Here, the piezoelectric module 504 may be exposed to the outside environment.

As illustrated in FIG. 11B, one or more sockets, such as two sockets may be included to be supplied with a sound source signal output from the control unit 100 or the amplification unit 300. In FIG. 11B, two sockets are disposed on the inner surface 11a of the case of the terminal. More specifically, a first socket 544 and a second socket 554 are illustrated in FIG. 11B.

Another socket that may be electrically connected to the sockets for transmitting signals may be disposed in the main body of the terminal 1. The socket formed in the main body, which may be referred to as a main body socket, may be configured to be electrically connected to the case when the case is joined to the main body of the terminal.

In addition, the socket may be electrically connected to the piezoelectric module 504, and an electrical signal line that penetrates through the case may be formed. The piezoelectric module 504 may be formed in a form of decorative design, words, logos, symbols, and the like, which may be disposed on the exterior of the terminal.

Further, the piezoelectric module 504 may be formed in a single form that is connected, or a plurality of piezoelectric modules 504 may be formed in a separate form based on the design, words, logos, symbols, and the like to be expressed. When the plurality of piezoelectric modules 504 are in the separate form, each of the piezoelectric modules 504 may be electrically connected to at least one of the first socket 544 and the second socket 554. In addition, a coating layer for protecting the exposed piezoelectric modules 504 may be formed or disposed thereon.

Since the piezoelectric module 504 is adhered to the outer surface 11b of the case of the terminal and exposed to the outside environment, vibration generated by the piezoelectric module 504 may be transmitted to the external contact medium. Therefore, when the terminal is placed on the external contact medium, such as a box or a table, the box or the table may act as the vibration plate to generate a sound.

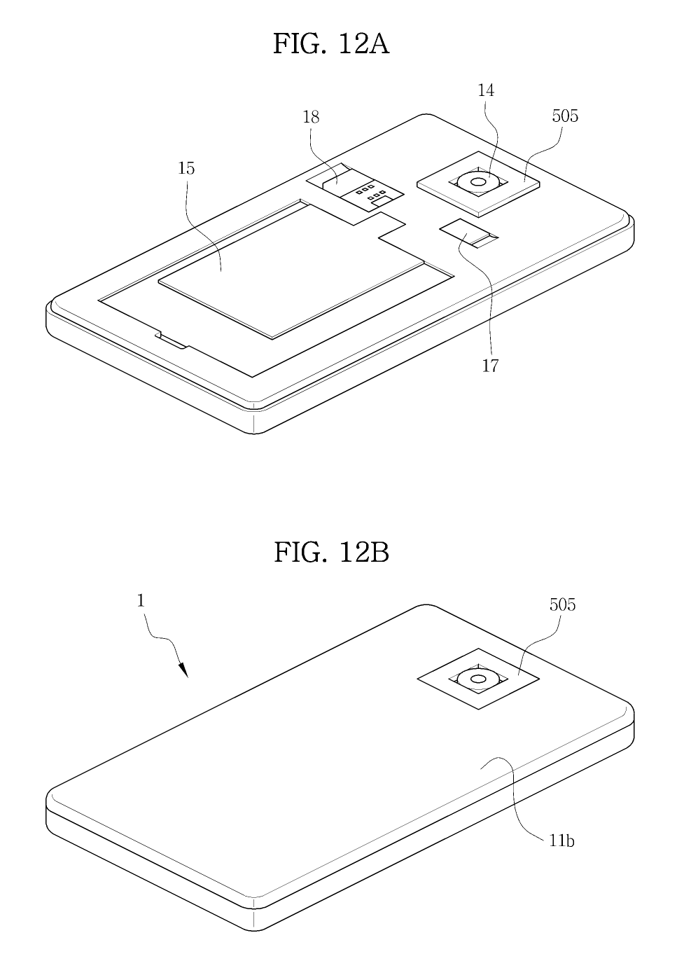

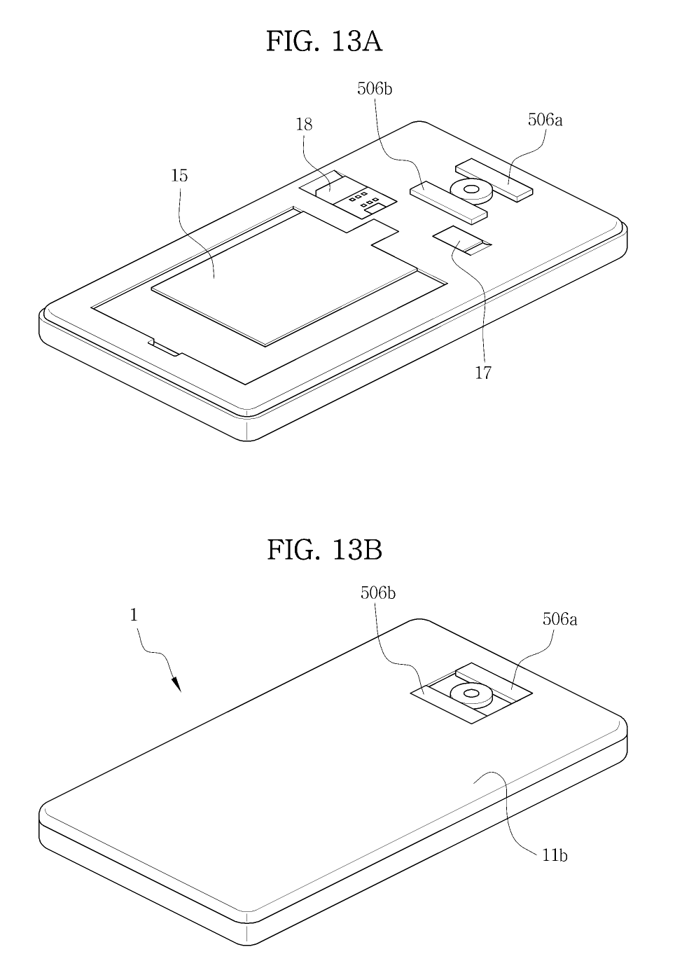

FIG. 12A and FIG. 12B are diagrams illustrating a configuration of a terminal according to exemplary embodiments of the present invention. FIG. 13A and FIG. 13B are diagrams illustrating a configuration of a terminal according to exemplary embodiments of the present invention.

Referring to FIG. 12A, a piezoelectric module 505 is disposed to be exposed to the outside of the terminal 1 in a decorative form. Further, the piezoelectric module 505 is disposed in the decorative form that surrounds the periphery of a camera 14. However, aspects of the invention are not limited thereto and various decorative forms may be designed on the outer surface 11b of the case 11. Further, a piezoelectric module may be disposed within a reference proximity of a camera.

As illustrated in FIG. 12B, when the case 11 is joined, the piezoelectric module 505 may be on the same plane as the case 11 or on a higher plane to protrude therefrom.

In addition, referring to FIG. 13A and FIG. 13B, the number of piezoelectric modules, including a first piezoelectric module 506a and a second piezoelectric module 506b, may be disposed. However, aspects of the invention are not limited thereto, such that the number of piezoelectric modules may be two or more. Further, the piezoelectric modules may be disposed to be separated from each other or to be adjacent to each other. Here, a first socket and a second socket that apply a sound source signal output from the control unit 100 or the amplification unit 300 may be connected to each other.

The first piezoelectric module 506a and the second piezoelectric module 506b may be similar in shape and disposed in parallel from one another. However, aspects of the invention are not limited thereto, such that the shapes and positions of the first piezoelectric module 506a and the second piezoelectric module 506b may be varied in design.

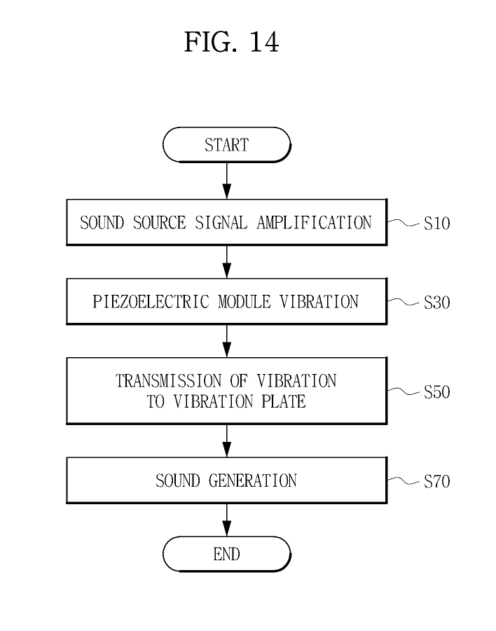

FIG. 14 is a flowchart illustrating a method for operating a piezoelectric speaker according to an exemplary embodiment of the present invention.

The method for operating a piezoelectric speaker may be performed in similar configuration as that of the piezoelectric speaker system 10 of FIG. 3. Therefore, like elements, which may be similar or the same as those of the piezoelectric speaker system 10 of FIG. 3, may be denoted by like reference numerals, and repeated descriptions thereof will be omitted.

Referring to FIG. 14, in operation S10, the sound source signal is amplified. The sound source signal may be outputted from the control unit 100, and the amplified sound source signal may have a voltage above a reference threshold, for example, an alternating current voltage of 10 Vpp or higher.

In operation S30, the amplified sound source signal is transmitted to the piezoelectric module 500, and the piezoelectric module 500 vibrates according to the sound source signal. The piezoelectric module 500 may include the piezoelectric element, which, when the sound source signal is received, vibrates by repeatedly contracting and relaxing.

The vibration of the piezoelectric module 500 is transmitted to the vibration plate 700 (S50), thereby generating sound (S70). The vibration plate 700 may be the case of the terminal or a contact medium outside the terminal.

In the method for operating a piezoelectric speaker according to exemplary embodiments of the present invention, an additional vibration plate is not included. Accordingly, the volume of the piezoelectric speaker may be reduced when compared to the piezoelectric speaker with a vibration plate. In addition, various tones may be reproduced based on the material of the vibration plate 700.

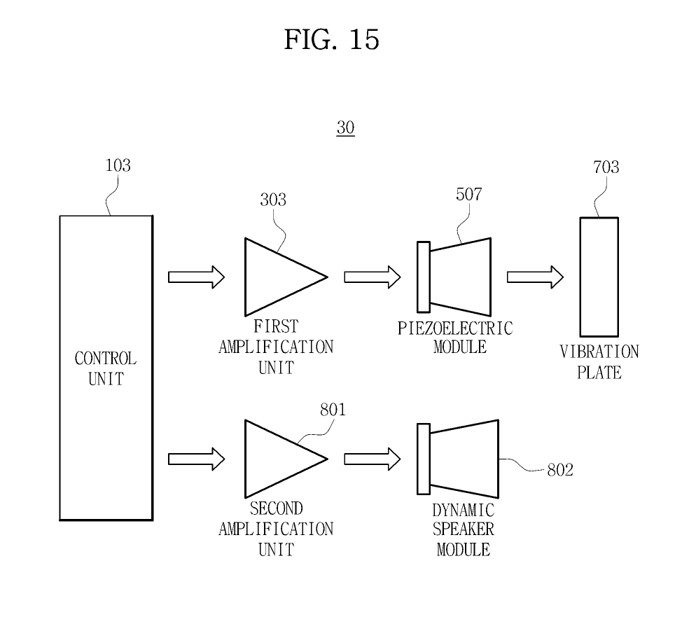

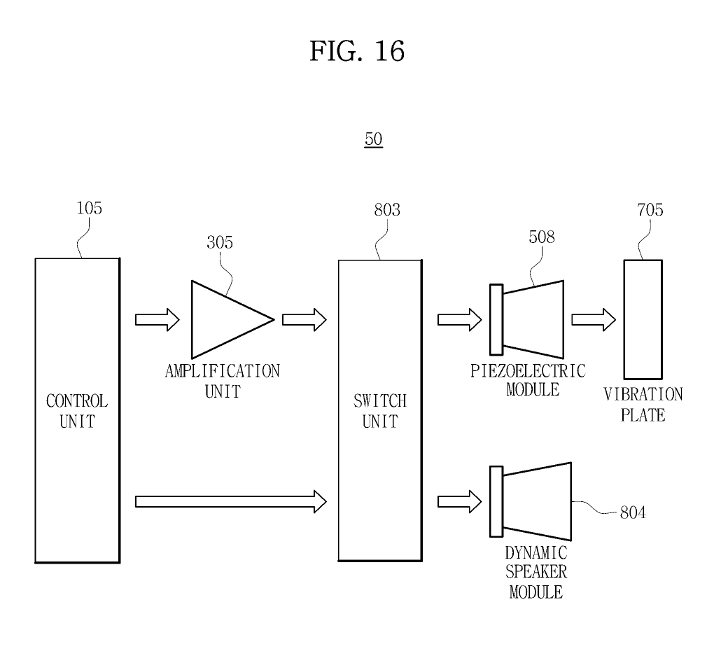

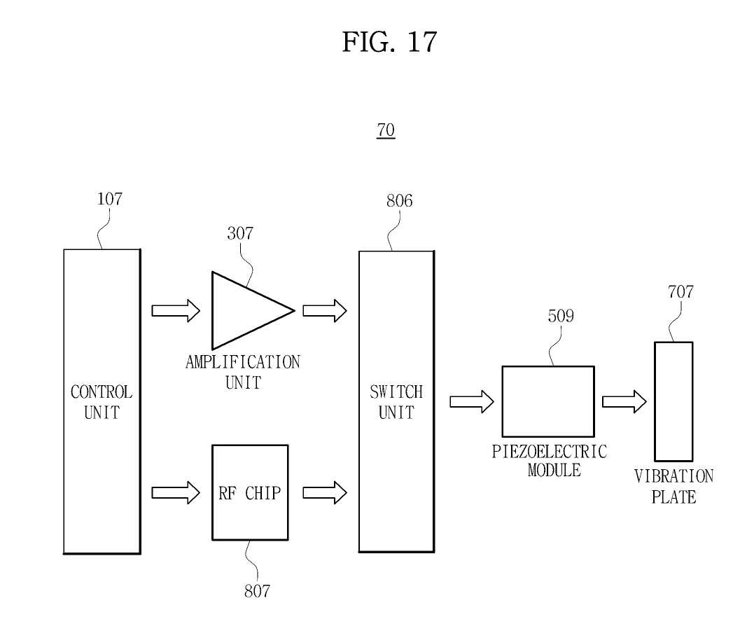

Hereinafter, exemplary application of a piezoelectric speaker system of the terminal will be described with reference to FIG. 15, FIG. 16, and FIG. 17. Piezoelectric speaker systems described hereinafter may be substantially similar or the same as the piezoelectric speaker system 10 of FIG. 3, and thus repeated descriptions of similar or the same components as those of the piezoelectric speaker system 10 of FIG. 3 will be simplified or omitted.

FIG. 15 is a block diagram illustrating a configuration of a piezoelectric speaker system according to exemplary embodiments of the present invention.

Referring to FIG. 15, a dual speaker system 30 includes a piezoelectric speaker system and a dynamic speaker system. The piezoelectric speaker system includes a control unit 103, a first amplification unit 303, a piezoelectric module 507, and a vibration plate 703. The dynamic speaker system includes the control unit 103, a second amplification unit 801, and a dynamic speaker module 802.

The dual speaker system 30 includes the first amplification unit 303 and the second amplification unit 801 for the piezoelectric module 507 and the dynamic speaker module 802, respectively. The dual speaker system 30 may be able to selectively/simultaneously output sound through the piezoelectric module 507 and the dynamic speaker module 802. More specifically, a dual speaker structure including the piezoelectric speaker system and the dynamic speaker system may be achieved. The number of piezoelectric speaker systems and dynamic speaker systems included may be one or more.

The dynamic speaker module 802 or the dynamic speaker system may be a general speaker applied to an existing terminal. Generally, the resonance space of the general speaker of a terminal may be small and thus it may be difficult to appropriately express sounds in a low note range. Further, the piezoelectric speaker system may ensure a larger resonance space than the existing terminal when an external contact medium is used as the vibration plate, such that sound in a low note range may be reproduced. Therefore, the piezoelectric speaker system may be configured to be in charge of a low note range, and the dynamic speaker system may be configured to be in charge of a high note range.

The dual speaker system 30 may use the piezoelectric speaker system and the dynamic speaker system simultaneously, or one of the speaker systems may be selectively used. When one of the speaker systems is selectively used, the control unit 103 may output a sound source signal to the selected speaker system and block outputting of the sound source signal to the other speaker system.

FIG. 16 is a block diagram illustrating a configuration of a piezoelectric speaker system according to exemplary embodiments of the present invention.

Referring to FIG. 16, a mode switch speaker system 50 includes a control unit 105, an amplification unit 305, a switch unit 803, a piezoelectric module 508, a vibration plate 705, and a dynamic speaker module 804.

Referring to FIG. 16, the single amplification unit 305 is provided for the piezoelectric module 508 and the dynamic speaker module 804, and the switch unit 803 to provide a switch operation is provided. Therefore, sound may be selectively output through the piezoelectric module 508 and the dynamic speaker module 804. More specifically, the mode switch speaker system 50 may operate in a piezoelectric speaker mode or a dynamic speaker mode.

The switch unit 803 may provide a sound source signal output from the amplification unit 305 to the piezoelectric module 508 or the dynamic speaker module 804. The operation mode of the mode switch speaker system 50 may be set to a particular mode based on the setting of a user or may also be set to an appropriate mode for the output sound source signal. The control unit 105 may output a control signal, which may be used for controlling the switch unit 803 to choose between the piezoelectric module 508 and the dynamic speaker module 804 to provide the sound source signal.

FIG. 17 is a block diagram illustrating a configuration of a piezoelectric speaker system according to exemplary embodiments of the present invention.

Referring to FIG. 17, antenna system 70 includes a control unit 107, an amplification unit 307, a switch unit 806, a piezoelectric module 509, a vibration plate 707, and an RF chip 807. The antenna system 70 may operate in the piezoelectric speaker mode or an antenna mode.

The control unit 107 may output a sound source signal or a communication signal, and the communication signal may be modulated by the RF chip 807. Based on the piezoelectric is speaker mode and the antenna mode, the switch unit 806 may filter the sound source signal and the communication signal to be transmitted to the piezoelectric module 509.

The operation mode of the antenna system 70 may be set based on the setting of a user or may also be set to an appropriate mode for an operation or application executed by the terminal. The control unit 107 may output a control signal for controlling the switch unit 806 to choose between piezoelectric speaker mode and the antenna mode to operate the piezoelectric module 509.

When operating in the antenna mode, the piezoelectric module 509 may radiate and transmits the received communication signal. Further, when operating in the piezoelectric speaker mode, the piezoelectric module 509 may output the received sound source signal and may output sound with various sound volumes and tones through the vibration plate.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A terminal having a piezoelectric speaker system, comprising:
a control unit to generate a sound source signal;
a first amplification unit to provide a voltage to amplify the sound source signal; and
a piezoelectric module to vibrate according to the amplified sound source signal, the piezoelectric module being configured to transmit vibrations to a contact medium to generate a first sound.

2. The terminal of claim 1, wherein the contact medium is included in the terminal.

3. The terminal of claim 1, wherein the contact medium is a vibration plate.

4. The terminal of claim 3, wherein the first sound is generated according to at least one of a size of the vibration plate, a shape of the vibration plate, material of the vibration plate, and a size of a resonance space.

5. The terminal of claim 1, wherein the contact medium is disposed external to the terminal.

6. The terminal of claim 1, wherein the contact medium is a case of the terminal.

7. The terminal of claim 1, wherein the piezoelectric module comprises:
a piezoelectric element to generate electric polarization when the voltage is applied;
a first electrode disposed at a first portion of the piezoelectric element;
a second electrode disposed at a second portion of the piezoelectric element;
a first socket connected to the first electrode; and
a second socket connected to the second electrode.

8. The terminal of claim 1, further comprising:
a dynamic speaker module to generate a second sound; and
a second amplification unit to amplify the sound source signal to be used by the dynamic speaker.

9. The terminal of claim 1, further comprising:
a dynamic speaker module to generate a second sound; and
a switch unit to provide the amplified sound source signal to at least one of the piezoelectric module and the dynamic speaker module.

10. The terminal of claim 1, further comprising:
a radio frequency (RF) chip to modulate a communication signal; and
a switching unit to filter the sound source signal and the communication signal to be transmitted to the piezoelectric module,
wherein the control unit selectively transmits the communication signal to the RF chip.

11. The terminal of claim 1, wherein the piezoelectric module is disposed on the contact medium.

12. The terminal of claim 1, wherein the piezoelectric module further comprises:
a coating layer to adhere the piezoelectric module to the contact medium.

13. The terminal of claim 7, wherein at least one of the first socket and the second socket is a flexible printed circuit board (FPCB).

14. The terminal of claim 7, further comprising:
an enclosure to enclose the piezoelectric element; and
at least one buffer disposed between a surface of the piezoelectric element and a surface of the enclosure.

15. The terminal of claim 1, wherein the piezoelectric module is configured to transmit the vibrations to the contact medium by at least one of a direct contact, an indirect contact, and the piezoelectric module and the contact medium being disposed within a reference proximity.

16. The terminal of claim 1, further comprising:
a case comprising an interior surface and an external surface,
wherein the piezoelectric module is exposed to an external environment through an opening in the case.

17. The terminal of claim 1, further comprising:
a case comprising an interior surface and an external surface,
wherein the piezoelectric module is adhered to the interior surface or the exterior surface of the case.

18. The terminal of claim 1, wherein the piezoelectric module comprises a socket to receive at least one of the sound source signal and the amplified sound source signal.

19. The terminal of claim 1, further comprising:
a case comprising an interior surface and an external surface; and
a camera module disposed in the terminal to be exposed through an opening in the case,
wherein the piezoelectric module is disposed on a periphery of the camera module.

20. A method for generating a sound using a piezoelectric speaker, comprising:
amplifying a sound source signal;
generating a vibration in a piezoelectric module according to the amplified sound source signal; and
transmitting vibration to a contact medium for generating the sound.
